(19) United States
(12) Patent Application Publication
(10) Pub. No.: US 2023/0126755 A1
(43) Pub. Date: Apr. 27, 2023

(54) INFORMATION PROCESSING APPARATUS, INFORMATION PROCESSING METHOD, AND IMAGING SYSTEM

(71) Applicant: SONY GROUP CORPORATION, TOKYO (JP)

(72) Inventor: YUYA YAMASHITA, TOKYO (JP)

(21) Appl. No.: 17/907,629

(22) PCT Filed: Mar. 18, 2021
(86) PCT No.: PCT/JP2021/011227

§ 371 Date: Sep. 28, 2022

(30) Foreign Application Priority Data
Apr. 10, 2020 (JP) 2020-070930

(51) Int. Cl. G06T 7/73; G06T 5/00; G06T 7/246

(52) U.S. Cl. CPC G06T 7/74; G06T 5/002; G06T 7/248; G06T 2207/30196

(57) ABSTRACT

An information processing apparatus includes a definition processing unit that performs definition processing on feature amount information regarding a subject specified from an image. Therefore, for example, feature amount information such as posture information can be obtained with high accuracy.

### TECHNICAL FIELD

The present technology relates to an information processing apparatus, an information processing method, and an imaging system, and particularly relates to a technology of performing processing on a feature amount of a subject.

### BACKGROUND ART

There is known a technology of imaging a subject using a plurality of imaging apparatuses and obtaining three-dimensional data of the subject from the captured images obtained by the imaging apparatuses. For example, Patent Document 1 below discloses a technology using a plurality of imaging apparatuses to restore a three-dimensional shape from two-dimensional image information with high accuracy.

### CITATION LIST

### Patent Document

Patent Document 1: Japanese Patent Application Laid-Open No. 2010-072700

### SUMMARY OF THE INVENTION

### Problems to be Solved by the Invention

In such a technique, it is more desirable as the three-dimensional shape to be restored has higher accuracy.

The present technology has been made in view of such circumstances, and an object thereof is to obtain highly accurate feature amount information from two-dimensional image information.

### Solutions to Problems

An information processing apparatus according to the present technology includes a definition processing unit that performs definition processing on feature amount information regarding a subject specified from an image.

The feature amount information is, for example, posture information, or the like. Furthermore, as the definition processing, definition processing in a time direction, definition processing in a spatial direction, or the like can be considered.

The above-described information processing apparatus may include a smoothing processing unit that performs smoothing processing on the feature amount information after the definition processing.

Therefore, the feature amount information is corrected to be more accurate.

In the above-described information processing apparatus, the feature amount information may be posture information on a subject.

Thus, the posture information on the subject is defined in the time direction and is defined in the spatial direction.

In the above-described information processing apparatus, the image may include a first captured image captured by a first imaging apparatus and a second captured image captured by a second imaging apparatus different from the first imaging apparatus.

By defining the feature amount information regarding the subject such as the posture information using the captured images captured by the plurality of imaging apparatuses, the feature amount information can be grasped more accurately.

In the above-described information processing apparatus, the first captured image may be an image having a higher resolution than the second captured image.

Thus, as for the second imaging apparatus that captures the second captured image, it is possible to adopt an imaging apparatus that can capture only a captured image having a lower resolution than the first imaging apparatus that captures the first captured image.

In the above-described information processing apparatus, the second captured image may be an image captured at a higher frame rate than the first captured image.

Thus, as for the first imaging apparatus that captures the first captured image, it is possible to adopt an imaging apparatus that can capture only a captured image having a lower frame rate than the second imaging apparatus that captures the second captured image.

The definition processing unit in the information processing apparatus may perform definition in a spatial direction using the first captured image for the feature amount information specified from the second captured image as the definition processing.

Therefore, it is possible to correct the spatial direction of the feature amount information specified from the captured image having a relatively low resolution.

The definition processing unit in the information processing apparatus may perform definition in a time direction using the second captured image for the feature amount information specified from the first captured image as the definition processing.

Therefore, missing information in the time direction can be compensated for the feature amount information specified from the captured image having a relatively low frame rate.

The above-described information processing apparatus may include a feature amount specifying unit that specifies the feature amount information from the image.

Since both the feature amount specifying unit and the definition processing unit are provided in the information processing apparatus, each processing can be smoothly performed.

The feature amount specifying unit in the information processing apparatus may specify posture information on a subject as the feature amount information by performing skeleton estimation processing of estimating a skeleton of the subject.

Therefore, the posture information based on the skeleton information estimated for the subject is obtained, and the definition processing for the skeleton information is performed.

The information processing apparatus described above may include a three-dimensionalization processing unit that generates three-dimensional posture information using the feature amount information after the definition processing has been applied.

Therefore, feature amount information such as skeleton information obtained from the two-dimensional image is three-dimensionalized.

The above-described information processing apparatus may include a motion analysis unit that performs motion analysis of the subject using the three-dimensional posture information.

Therefore, the motion of the subject can be analyzed with high accuracy on the basis of the three-dimensionalized posture information.

In the information processing apparatus described above, in a case where there is a plurality of high-resolution imaging apparatuses that has captured an image having a higher resolution than the second captured image, the definition processing unit may select the first captured image to be used for definition in the spatial direction from among the high-resolution images on the basis of likelihood information in the high-resolution image for each of the high-resolution imaging apparatuses.

Therefore, an appropriate first captured image is selected in the definition processing.

In the above-described information processing apparatus, in a case where there is a plurality of high frame rate imaging apparatuses that has captured an image having a higher frame rate than the first captured image, the definition processing unit may select the second captured image to be used for definition in the time direction from among the high frame rate images on the basis of likelihood information in the high frame rate image for each of the high frame rate imaging apparatuses.

Therefore, an appropriate second captured image is selected in the definition processing.

In the above-described information processing apparatus, the likelihood information may be calculated for a joint of the subject.

Therefore, an appropriate captured image is selected for each joint of the subject.

The above-described information processing apparatus may include a display image data generation unit that generates display image data in which the posture information is superimposed on the image.

Therefore, a display image useful for analyzing the posture information on the subject is generated.

In an information processing method according to the present technology, an information processing apparatus executes definition processing on feature amount information regarding a subject specified from an image.

An imaging system according to the present technology includes a first imaging apparatus that captures a first captured image, a second imaging apparatus that captures a second captured image with at least one of a resolution or a frame rate different from that of the first captured image, and a definition processing unit that performs definition processing on the first captured image using the second captured image.

### BRIEF DESCRIPTION OF DRAWINGS

FIG. 1 is a diagram illustrating a configuration example of an analysis system according to a first embodiment.

FIG. 2 is a diagram illustrating a configuration example of a time direction definition processing unit.

FIG. 3 is a diagram illustrating an example of imaging timings of a high-resolution camera and a high-fps camera.

FIG. 4 is a diagram illustrating joint positions estimated from a high-resolution image.

FIG. 5 is a diagram illustrating joint positions and epipolar lines estimated from a low-resolution image.

FIG. 6 is a diagram for explaining definition processing in a spatial direction.

FIG. 7 is a diagram illustrating joint positions estimated from a low-resolution image.

FIG. 8 is a diagram illustrating epipolar lines on a high-resolution image.

FIG. 9 is a diagram for explaining definition processing in a time direction.

FIG. 10 is a diagram for explaining another example of the definition processing in the time direction.

FIG. 11 is a diagram for explaining smoothing processing.

FIG. 12 is a diagram illustrating a configuration example of an information processing apparatus.

FIG. 13 is a flowchart of a processing example according to the first embodiment.

FIG. 14 is a flowchart of one example of time direction definition processing.

FIG. 15 is a flowchart of one example of motion analysis processing.

FIG. 16 is a diagram illustrating a configuration example of an analysis system according to a second embodiment.

FIG. 17 is a flowchart of a processing example according to the second embodiment.

FIG. 18 is a diagram illustrating a configuration example of an analysis system according to a third embodiment.

FIG. 19 is a diagram illustrating one example of output image data according to the third embodiment.

FIG. 20 is a flowchart of a processing example according to the third embodiment.

FIG. 21 is a diagram illustrating a configuration example of an analysis system according to a fourth embodiment.

FIG. 22 is a diagram illustrating an example of estimated joint positions and likelihood information.

FIG. 23 is a flowchart of a processing example according to the fourth embodiment.

### MODE FOR CARRYING OUT THE INVENTION

Hereinafter, exemplary embodiments will be described in the following order.

<1. First Embodiment>

<1-1. Configuration of Analysis System>

<1-2. Configuration of Information Processing Apparatus>

<1-3. Processing Example>

<2. Second Embodiment>

<2-1. Configuration of Analysis System>

<2-2. Processing Example>

<3. Third Embodiment>

<3-1. Configuration of Analysis System>

<3-2. Processing Example>

<4. Fourth Embodiment>

<4-1. Configuration of Analysis System>

<4-2. Processing Example>

<5. Modification Examples>

<6. Summary>

<7. Present Technology>

### 1. First Embodiment

<1-1. Configuration of Analysis System>

An image analysis system 1 according to a present embodiment estimates a feature amount of a subject using a plurality of imaging apparatuses. In a first embodiment, an example using two imaging apparatuses will be described.

A first imaging apparatus and a second imaging apparatus as two imaging apparatuses included in the image analysis system 1 are different in imaging performance.

Specifically, the first imaging apparatus is a high-resolution imaging apparatus such as 4K or 8K. Furthermore, the second imaging apparatus has lower resolution (e.g., HD resolution) than the first imaging apparatus.

Moreover, the first imaging apparatus and the second imaging apparatus are different in the number of captured images per unit time in the moving image. For example, the first imaging apparatus can perform imaging at 120 frame per second (fps), and the second imaging apparatus can perform imaging at 240 fps. Note that the value of the frame rate is merely an example. Furthermore, for example, the ratio of the frame rates may be not 1:2 so that the first imaging apparatus has 60 fps and the second imaging apparatus has 240 fps.

In the following description, the first imaging apparatus will be referred to as a “high-resolution camera”, and the second imaging apparatus will be referred to as a “high-fps camera”.

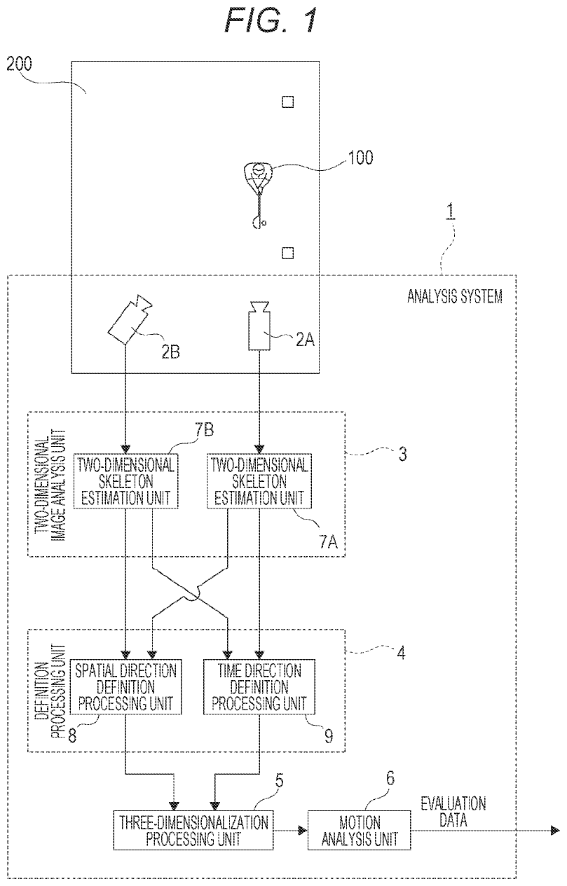

In the present example, the analysis system 1 analyzes the golf swing motion performed by a subject. Therefore, the analysis system 1 specifies posture information as the feature amount of the subject by estimating the posture of the subject. A specific configuration of the analysis system 1 will be described with reference to FIG. 1.

FIG. 1 illustrates a scene where swing analysis of a subject 100 who is playing golf is performed by the analysis system 1. Specifically, the scene is where the subject 100 is about to hit a tee shot in a teeing area 200.

The analysis system 1 includes a high-resolution camera 2A and a high-fps camera 2B, which capture an image of the subject 100. The analysis system 1 further includes a two-dimensional image analysis unit 3, a definition processing unit 4, a three-dimensionalization processing unit 5, and a motion analysis unit 6.

As described above, the high-resolution camera 2A is a camera that can obtain a captured image having a higher resolution than the high-fps camera 2B.

Furthermore, the high-fps camera 2B is a camera capable of imaging at a higher fps than the high-resolution camera 2A.

Note that, in a case where a camera that images the subject 100 is indicated without distinguishing the high-resolution camera 2A and the high-fps camera 2B, the camera is simply referred to as an “imaging apparatus 2”.

The high-resolution camera 2A and the high-fps camera 2B can perform synchronous imaging operation. That is, in a case where the high-resolution camera 2A captures an image at 120 fps and the high-fps camera 2B captures an image at 240 fps, a half of the captured images captured by the high-fps camera 2B is captured simultaneously with the high-resolution camera 2A.

The two-dimensional image analysis unit 3 specifies posture information as a feature amount by estimating the skeleton of the subject 100 on the basis of the captured image data acquired from the imaging apparatus 2. Specifically, the two-dimensional image analysis unit 3 includes a two-dimensional skeleton estimation unit 7A that performs skeleton estimation for the captured image data of the high-resolution camera 2A, and a two-dimensional skeleton estimation unit 7B that performs skeleton estimation for the captured image data of the high-fps camera 2B.

The two-dimensional skeleton estimation units 7A and 7B may be provided in the same information processing apparatus or may be provided in different information processing apparatuses.

The two-dimensional skeleton estimation units 7A and 7B estimate the skeleton (joint or bone) of the subject 100 in the two-dimensional image by using a convolutional neural network (CNN), which is a type of deep neural network (DNN) and is often used for image analysis, for example.

In the following description, the positions of joints and bones (such as skull) are collectively referred to as “joint positions”.

The estimation of the joint position is executed for each frame of the image captured by the imaging apparatus 2.

The information on the estimated joint position is output to the definition processing unit 4 as two-dimensional skeleton information.

The definition processing unit 4 performs definition processing in the spatial direction and definition processing in the time direction. For this purpose, the definition processing unit 4 includes a spatial direction definition processing unit 8 and a time direction definition processing unit 9.

For example, the spatial direction definition processing unit 8 performs spatial direction definition processing on a low-resolution image obtained by imaging by the high-fps camera 2B.

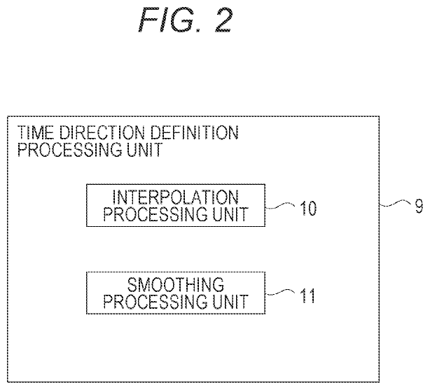

Furthermore, the time direction definition processing unit 9 includes, for example, an interpolation processing unit 10 that performs time direction interpolation processing on a low-fps image obtained by imaging by the high-resolution camera 2A, and a smoothing processing unit 11 that performs smoothing processing of two-dimensional skeleton information (see FIG. 2).

First, the spatial direction definition processing will be described.

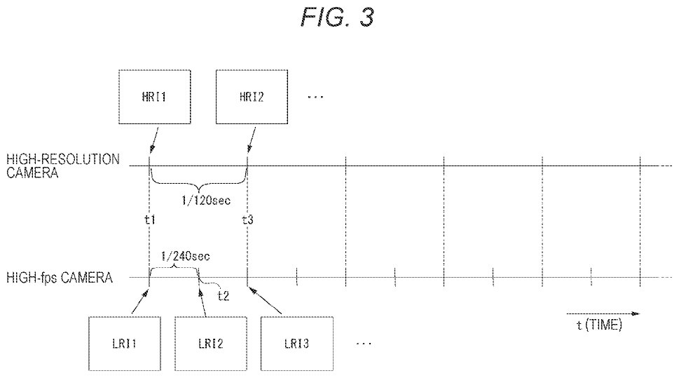

FIG. 3 illustrates imaging timings of the high-resolution camera 2A and the high-fps camera 2B, respectively.

As illustrated, high-resolution images HRI1, HRI2, and so on are captured from the high-resolution camera 2A every 1/120 sec. The time at which each image is captured is time t1 and time t3.

Furthermore, low-resolution images LRI1, LRI2, LRI3 and so on are captured from the high-fps camera 2B every 1/240 sec. The time at which each image is captured is time t1, t2 and time t3.

Since the captured image output from the high-fps camera 2B has a relatively low resolution, the accuracy of the joint position estimated as the joint position and the position (or orientation, or the like) of the bone estimated may be low.

In the definition processing in the spatial direction, definition of the estimated joint position using the high-resolution image HRI output from the high-resolution camera 2A is performed on a low-resolution image LRI of the high-fps camera 2B.

Specifically, in the spatial direction definition processing for the low-resolution image LRI1, the image of the high-resolution image HRI1 is used. Moreover, in the interpolation processing in the spatial direction for the low-resolution image LRI3, the image of the high-resolution image HRI2 is used. That is, image data captured at the same timing is used.

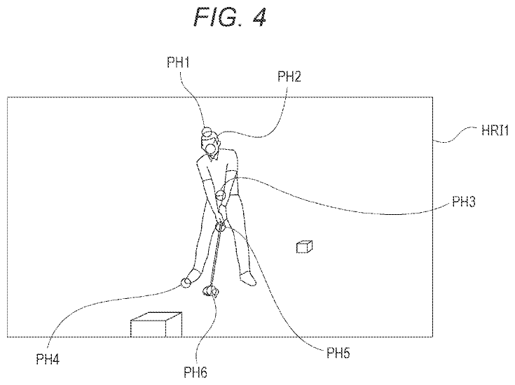

A specific example of the definition processing in the spatial direction (definition processing of joint positions and bone positions) will be described with reference to each of FIGS. 4 to 6.

FIG. 4 illustrates the high-resolution image HRI1 and the positions of the joints and the positions of the club as the estimated two-dimensional skeleton information in a superimposition manner. Note that the positions of the joints and the positions of the club illustrated in FIG. 4 are examples, and the positions of both shoulders, the positions of the wrists, the positions of the elbows, the positions of the knees, the positions of the right and left hips, the positions of the ankles, and the like can be estimated as the two-dimensional skeleton information in addition to the illustrated positions.

On the high-resolution image HRI1, PH1 indicating the position of the top of the head, PH2 indicating the position of the face, PH3 indicating the position of the navel, PH4 indicating the position of the toe of the right foot, PH5 indicating the position of the hand portion of the club, and PH6 indicating the position of the tip portion of the club are each superimposed.

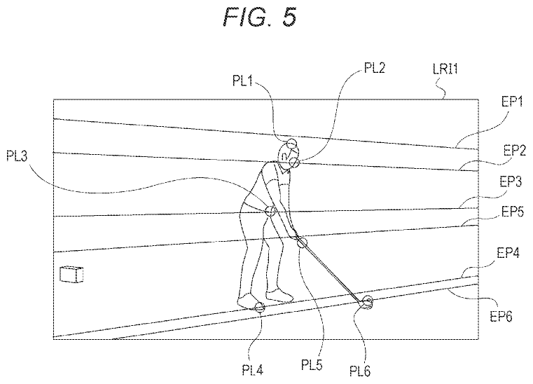

FIG. 5 illustrates positions at which these positions PH1 to PH6 of the respective units specified on the high-resolution image HRI1 can be located on the low-resolution image LRI1.

FIG. 5 illustrates epipolar lines EP1 to EP6 corresponding to the positions PH1 to PH6, respectively. Note that, in order to draw each of the epipolar lines EP1 to EP6 on the low-resolution image LRI1, position information on each imaging apparatus 2 is required.

The epipolar line is a virtual line connecting the high-resolution camera 2A and each position (top of head, face, navel and the like) of the subject 100 on the low-resolution image LRI1. That is, it is estimated that each unit in the subject 100 is located on each epipolar line.

FIG. 5 shows an epipolar line EP1 corresponding to a position PH1 for the top of the head, an epipolar line EP2 corresponding to a position PH2 for the face, an epipolar line EP3 corresponding to a position PH3 for the navel, an epipolar line EP4 corresponding to a position PH4 for the toe of the right foot, an epipolar line EP5 corresponding to a position PH5 for the hand portion of the club, and an epipolar line EP6 corresponding to a position PH6 for the tip portion of the club.

Furthermore, FIG. 5 illustrates the position of each unit with respect to the subject 100 estimated on the low-resolution image LRI1. Specifically, a position PL1 for the top of the head, a position PL2 for the face, a position PL3 for the navel, a position PL4 for the toe of the right foot, a position PL5 for the hand portion of the club, and a position PL6 for the tip portion of the club are superimposed on the low-resolution image LRI1.

As illustrated in FIG. 5, the positions PL2, PL3, PL4, and PL6 are located on the epipolar lines EP2, EP3, EP4, and EP6, respectively. Therefore, as for the positions PL2, PL3, PL4, and PL6, the positions estimated in each of the high-resolution image HRI1 and the low-resolution image LRI1 can be regarded as matching.

On the other hand, the position PL1 is located at a position deviated from the epipolar line EP1. PL5 is also located at a position deviated from the epipolar line EP5.

Therefore, the estimated position information on the positions PL1 and PL5 may possibly be incorrect.

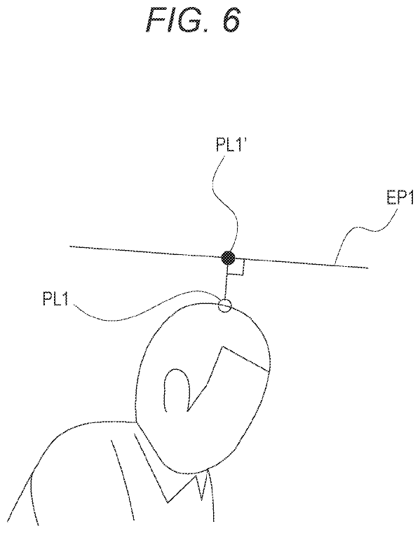

Therefore, processing of correcting the positions PL1 and PL5 is performed. For example, the position of the top of the head is corrected by moving the position PL1 of the top of the head to a point (position PL1′) on the epipolar line EP1 (see FIG. 6). Specifically, a position obtained by drawing a perpendicular line from the position PL1 onto the epipolar line EP1 is referred to as a position PL1′.

Furthermore, as for the position PL5 with respect to the hand portion of the club, a position obtained by drawing a perpendicular line on the epipolar line EP5 is referred to as a position PL5′.

In this way, the spatial direction definition processing using the two-dimensional skeleton information estimated from the high-resolution image HRI is performed on each position PH of the subject 100 (or the tool or the like used by the subject 100) estimated on the low-resolution image LRI.

Thus, the two-dimensional skeleton information on the subject 100 estimated in the low-resolution image LRI can be made more accurate.

The definition processing in the spatial direction has been described above.

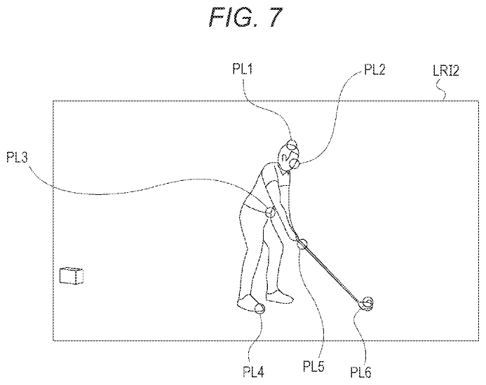

Next, the interpolation processing performed by the interpolation processing unit 10 of the time direction definition processing unit 9 will be described with reference to each of FIGS. 7 to 11.

Since the number of images captured per unit time is small, the high-resolution camera 2A is not suitable for capturing the time change of the two-dimensional skeleton information. Therefore, interpolation processing is performed as definition processing in the time direction using the captured image of the high-fps camera 2B.

FIG. 7 is an example of a low-resolution image LRI2 (see FIG. 3) captured by the high-fps camera 2B. As illustrated in FIG. 3, there is no high-resolution image HRI corresponding to the low-resolution image LRI2. That is, there is no high-resolution image HRI captured at the time t2.

The interpolation processing is processing of generating posture information (two-dimensional skeleton information) about the high-resolution image HRI at the time t2 that is the timing at which the low-resolution image LRI2 is captured. That is, the processing is processing of interpolating the two-dimensional skeleton information as the feature amount estimated from the high-resolution image HRI in the time direction.

A position PL1 for the top of the head, a position PL2 for the face, a position PL3 for the navel, a position PL4 for the toe of the right foot, a position PL5 for the hand portion of the club, and a position PL6 for the tip portion of the club are shown in the low-resolution image LRI2 illustrated in FIG. 7. The respective positions PL1 to PL6 for the subject 100 are positions specified from the low-resolution image LRI2.

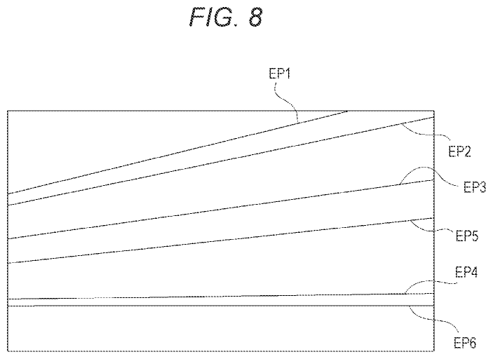

FIG. 8 illustrates epipolar lines EP1 to EP6 corresponding to the positions PL1 to PL6 of the subject 100 on the angle of view of the high-resolution camera 2A. As illustrated in FIG. 8, since a high-resolution image HRI does not exist, the subject 100 is not captured on the image.

Herein, the flow of the interpolation processing will be described by taking the position PL1 for the top of the head of each part of the subject 100 as an example.

In the interpolation processing, the high-resolution image HRI1 captured at the time t1 immediately before the low-resolution image LRI2 is captured and the high-resolution image HRI2 captured at the time t3 immediately after the low-resolution image LRI2 is captured are used.

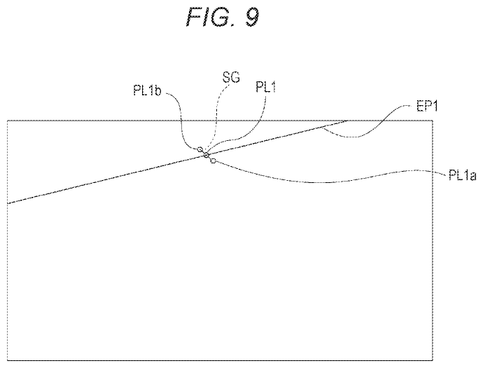

FIG. 9 illustrates a position PL1b of the top of the head at the time t1 estimated from the high-resolution image HRI1 captured at the time t1 and a position PL1a of the top of the head at the time t3 estimated from the high-resolution image HRI2 captured at the time t3. Further, the epipolar line EP1 corresponding to the position PL1 of the top of the head at the time t2 is illustrated. The top of the head of the subject 100 at the time t2 is likely to be located on the epipolar line EP1.

In this case, there is a high possibility that the top of the head at the time t2 is located at a position PL1 where a line segment SG (broken line in FIG. 9) connecting the position PL1b of the top of the head at the time point t1 and the position PL1a of the top of the head at the time t3 intersects the epipolar line EP1.

The interpolation processing is processing of estimating the position of each unit at the time t2 in the angle of view of the high-resolution camera 2A as described above.

FIG. 9 illustrates an example in which a line segment SG connecting the position PL1b and the position PL1a intersects with the epipolar line EP1. In some cases, the line segment SG and the epipolar line EP may be not intersect.

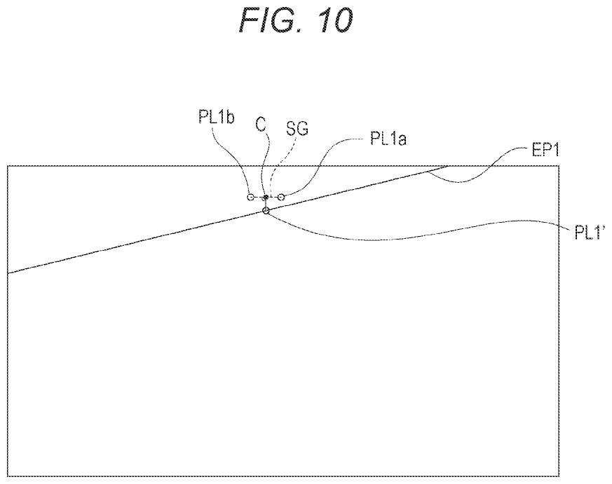

This will be specifically described with reference to FIG. 10.

In a case where the line segment SG connecting the position PL1b and the position PL1a does not intersect with the epipolar line EP1, as described above, the position where the line segment SG intersects with the epipolar line EP1 cannot be estimated as the position PL1 of the top of the head.

In this case, for example, a perpendicular line passing through the midpoint C of the line segment SG is drawn down from the epipolar line EP1 to the line segment SG, and an intersection of the perpendicular line and the epipolar line EP1 can be estimated as the position PL1 of the top of the head of the subject 100 at the time t2.

Alternatively, a perpendicular line may be drawn from the midpoint C of the line segment SG with respect to the epipolar line EP1, and an intersection of the perpendicular line and the epipolar line EP1 may be estimated as the position PL1 of the top of head.

Next, the smoothing processing executed by the smoothing processing unit 11 of the time direction definition processing unit 9 will be described.

The smoothing processing is processing of correcting the estimation result of the position of each unit of the subject 100 on the assumption that the movement of each unit of the subject 100 over time is smooth. For example, the position PL1 of the top of the head is corrected so that the time change of the position of the top of the head of the subject 100 becomes smooth.

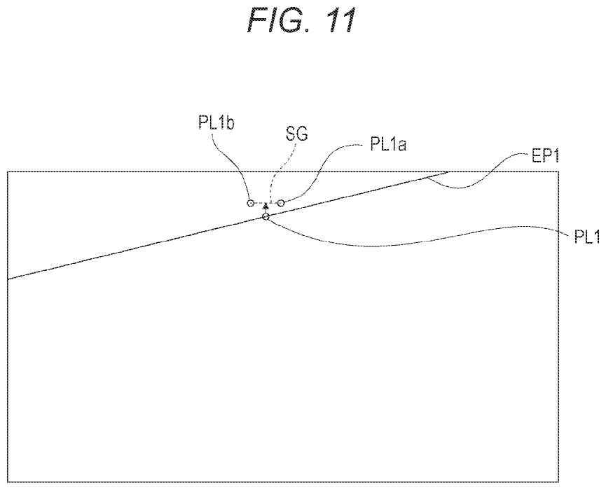

One example is illustrated in FIG. 11. FIG. 11 illustrates a position PL1b of the top of the head at the time t1, a position PL1 of the top of the head at the time t2, and a position PL1a of the top of the head at the time t3. That is, this indicates that the top of the head of the subject 100 has moved downward once and then moved upward.

Herein, suppose that the top of head smoothly moves, it is conceivable to correct upward the position PL1, which is the position of the top of head at the time t2. This correction may be made to move to a position above the line segment SG connecting the position PL1b and the position PL1a, or may be made to move slightly closer to the line segment SG.

In this way, the smoothing processing is performed for each position of each part (joint or the like) in the two-dimensional skeleton calculated as the feature amount.

Note that, although the example in which the smoothing is performed from the positions PL1b, PL1, and PL1a of the top of the head in the three images has been described herein, the smoothing may be performed using four or more images.

For example, the smoothing may be performed using the positions of the five top portions calculated from the five images. In this case, it is conceivable to perform smoothing using a second-order approximate curve or a third-order approximate curve.

By performing such smoothing, for example, even in a case where each part of the subject 100 performs a curved motion such as a circular motion, the posture information can be appropriately estimated.

The description returns to FIG. 1.

The low-resolution image data defined in the spatial direction by the spatial direction definition processing unit 8 and the high-resolution image data defined in the time direction by the time direction definition processing unit 9 are input into the three-dimensionalization processing unit 5 together with the two-dimensional skeleton information estimated in each image.

The three-dimensionalization processing unit 5 performs three-dimensionalization processing of a plurality of pieces of two-dimensional skeleton information. The three-dimensionalization processing is processing of generating three-dimensionalization skeleton information (three-dimensional skeleton information) using two-dimensional skeleton information. The three-dimensional skeleton information can also be referred to as three-dimensional posture information.

In the three-dimensionalization processing, camera calibration data such as position information on the high-resolution camera 2A and the high-fps camera 2B at the time of imaging is used. Furthermore, in the three-dimensionalization processing, information regarding the lens of the imaging apparatus 2 may be used.

As a method for generating three-dimensional information on the basis of two-dimensional information, various existing techniques can be used.

The three-dimensional skeleton information generated by the three-dimensionalization processing unit 5 is output to the motion analysis unit 6.

The motion analysis unit 6 analyzes the motion of the subject 100 on the basis of the three-dimensional skeleton information. Herein, analysis and evaluation of a golf swing are performed as one example of the motion analysis.

In the swing analysis processing, first, the movement of the top of the head, shoulder, elbow, wrist, waist, knee, ankle, and the like of the subject 100 and the movement of the hand or tip (club head) of the club are analyzed from the time-series data of the three-dimensional skeleton information on the subject 100. Then, from the analysis data, the moving speed of the knee, the moving speed and the rotating speed of the waist, the rotating speed and the moving amount of the chest, the movement of the shoulder, the moving speed of the hand of the club, the moving speed of the club head, the presence or absence of the vertical movement of the head, and the like are calculated.

Next, in the swing evaluation processing, an evaluation value of the golf swing is calculated from information such as the calculated moving speed and rotating speed of each part and presence or absence of movement. For example, the lower the head movement, the higher the evaluation value, and the higher the speed of the club head relative to the moving speed of the club's hand, the higher the evaluation value. Moreover, in a case where the peak of the moving speed shifts in the order of the knee, the waist, the shoulder, the hand of the club, and the club head, the evaluation value is increased.

In addition, it is possible to evaluate the swing on the basis of various indexes.

Note that these evaluation values may be calculated by machine learning using position information on each portion of the subject 100 and each portion of the golf club as an input and an evaluation value as an output. For example, supervised learning may be performed by providing teacher data in which a swing moving image (or data of a position and a motion of a joint) and its evaluation value (e.g., the shorter the distance between the falling point of the ball and the target such as a pin, the higher the evaluation value) are set, and the evaluation value may be calculated using the obtained learning model.

The evaluation value of the swing calculated in this manner is output from the analysis system 1 as evaluation data.

The evaluation data output from the analysis system 1 may be presented to the user as, for example, a numerical value of 0 to 100 or rank information on A to D. Alternatively, an evaluation value for each item such as swing speed and balance may be provided and presented to the user.

These pieces of evaluation data may be superimposed and displayed on an image captured by the imaging apparatus 2, for example, captured image data of the high-resolution camera 2A, or may be presented to the user together with the three-dimensional skeleton information generated by the three-dimensionalization processing unit 5. Furthermore, in that case, the three-dimensional skeleton information may be presented in such a form that the three-dimensional skeleton information can be freely rotated, or a period from the start to the end of the golf swing may be presented as moving image data. In the case of being presented as moving image data, the posture of the subject 100 at an arbitrary timing may be able to be confirmed.

<1-2. Configuration of Information Processing Apparatus>

The two-dimensional image analysis unit 3, the definition processing unit 4, the three-dimensionalization processing unit 5, and the motion analysis unit 6 are configured by a program or the like in one or a plurality of information processing apparatuses.

The information processing apparatus is, for example, a terminal apparatus with an arithmetic processing function, such as a general-purpose personal computer or a terminal apparatus for image processing. Note that the information processing apparatus may be a smartphone, a tablet terminal, or the like.

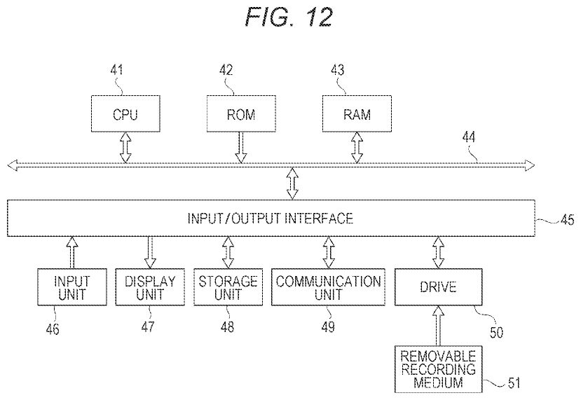

FIG. 12 is a diagram illustrating a configuration example of the information processing apparatus.

A CPU 41 of the information processing apparatus executes various processings according to a program stored in an ROM 42 or a program loaded from a storage unit 48 to an RAM 43. The RAM 43 also stores, as appropriate, data and the like necessary for the CPU 41 to execute various processings.

The CPU 41, the ROM 42, and the RAM 43 are connected to one another via a bus 44. This bus 44 is further connected to an input/output interface 45.

An input unit 46 including an operator and an operation device is connected to the input/output interface 45.

For example, as the input unit 46, various operators and operation devices such as a keyboard, a mouse, a key, a dial, a touch panel, a touch pad, and a remote controller are assumed. Alternatively, voice input or the like may be enabled.

An operation of the user is detected by the input unit 46, and a signal corresponding to the input operation is interpreted by the CPU 41.

Moreover, a display unit 47 including an LCD, an organic EL panel, or the like is integrally or separately connected to the input/output interface 45.

The display unit 47 is a display unit that performs various displays, and includes, for example, a display device provided in a housing of the information processing apparatus, a separate display device connected to the information processing apparatus, or the like.

The display unit 47 executes display of an image for various types of image processing, a moving image to be processed, and the like on a display screen on the basis of an instruction from the CPU 41. Moreover, the display unit 47 displays various operation menus, icons, messages, and the like, that is, displays as a GUI, on the basis of an instruction from the CPU 41.

In some cases, a storage unit 48 including a hard disk, a solid-state memory, or the like, and a communication unit 49 including a modem or the like are connected to the input/output interface 45.

The communication unit 49 performs communication processing via a transmission path such as the Internet, wired/wireless communication with various devices, bus communication, and the like.

In the case of the present embodiment, the communication unit 49 has a function of performing communication with a management terminal 104 by wired connection communication using a wired LAN, wireless connection communication using a wireless LAN, short-distance wireless communication, infrared communication, or the like.

A drive 50 is also connected to the input/output interface 45 as necessary, and a removable recording medium 51 such as a magnetic disk, an optical disk, a magneto-optical disk, or a semiconductor memory is mounted as appropriate.

By the drive 50, a data file such as an image file, various computer programs, and the like can be read out from the removable recording medium 51. The read out data file is stored in the storage unit 48, and images and sounds included in the data file are output by the display unit 47. Furthermore, the computer program and the like read out from the removable recording medium 51 are installed in the storage unit 48 as necessary.

In this information processing apparatus, for example, software for processing of the present disclosure can be installed via network communication by the communication unit 49 or the removable recording medium 51. Alternatively, the software may be stored in advance in the ROM 42, the storage unit 48, or the like.

For example, by such software, functional configurations such as the two-dimensional image analysis unit 3, the definition processing unit 4, the three-dimensionalization processing unit 5, and the motion analysis unit 6 illustrated in FIG. 1 are constructed in the CPU 41 of the information processing apparatus.

<1-3. Processing Example>

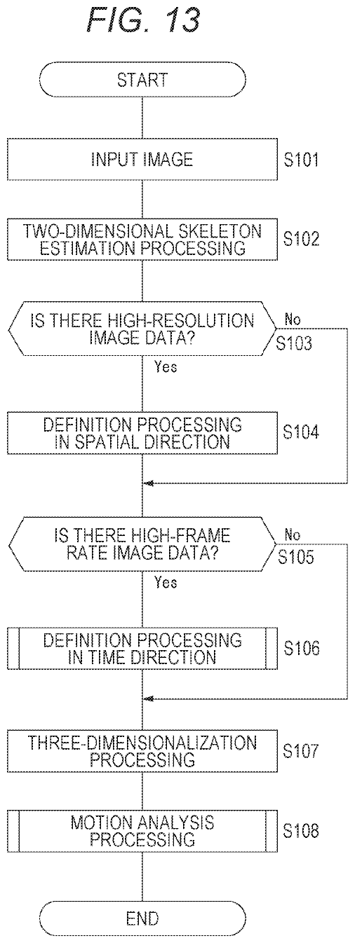

FIG. 13 illustrates one example of each processing executed by the CPU 41 of the information processing apparatus including the two-dimensional image analysis unit 3, the definition processing unit 4, the three-dimensionalization processing unit 5, and the motion analysis unit 6. Note that, as described above, the information processing apparatus may include a plurality of information processing apparatuses.

In step S101, the CPU 41 receives an image input. Specifically, image data output from the high-resolution camera 2A or the high-fps camera 2B is received.

In step S102, the CPU 41 performs two-dimensional skeleton estimation processing. In this processing, image analysis is performed on the high-resolution image HRI and the low-resolution image LRI to estimate the positions of the joints of the subject 100 and the like, thereby generating skeleton information on the subject.

In step S103, the CPU 41 performs branch processing according to whether or not there is image data with a higher resolution than the image data to be processed.

For example, in a case where the image data to be processed is the low-resolution image LRI captured by the high-fps camera 2B, it is determined that there is high resolution image data (“Yes” in the drawing) in the branch processing of step S103.

On the other hand, in a case where the image data to be processed is the high-resolution image HRI captured by the high-resolution camera 2A, it is determined that there is no high-resolution image data (“No” in the drawing) in the branch processing of step S103.

In a case where it is determined that there is the high-resolution image HRI, the CPU 41 executes definition processing in the spatial direction in step S104. The definition processing in the spatial direction is processing of correcting (modifying) the skeleton information estimated in the low-resolution image LRI using the skeleton information (e.g., the position information on the joint on the image) estimated in the high-resolution image HRI.

After executing the definition processing in the spatial direction in step S104, or in a case where it is determined that there is no high-resolution image HRI in step S103, the CPU 41 performs, in step S105, branch processing according to whether or not there is image data having a higher frame rate than the image data to be processed.

For example, in a case where the image data to be processed is the low-resolution image LRI captured by the high-fps camera 2B, it is determined that there is no high-fps image data (“No” in the drawing) in the branch processing of step S105.

On the other hand, in a case where the image data to be processed is the high-resolution image HRI captured by the high-resolution camera 2A, it is determined that there is high-fps image data (“Yes” in the drawing) in the branch processing of step S103.

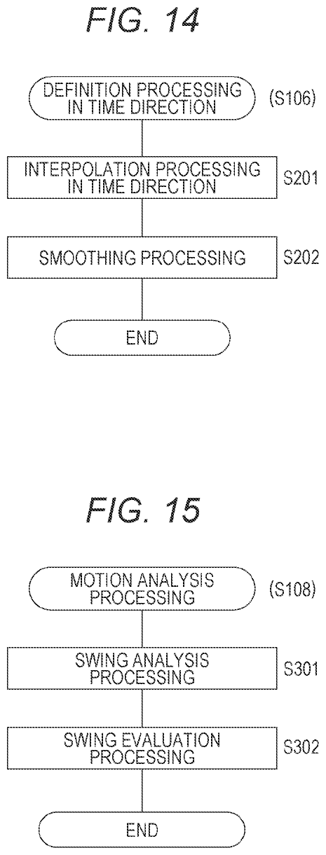

In a case where it is determined that there is high fps image data, the CPU 41 executes definition processing in the time direction in step S106. FIG. 14 illustrates one example of the definition processing in the time direction.

In the definition processing in the time direction, the CPU 41 executes interpolation processing in the time direction in step S201. As described with reference to FIG. 3, the interpolation processing in the time direction is processing of estimating the positions of the subject 100 and the object at the time t2 in the high-resolution image HRI. That is, it is processing for densifying the information in the time direction with respect to the two-dimensional skeleton information.

Next, in step S202, the CPU 41 executes smoothing processing. The smoothing processing is processing of correcting the position of each unit on the assumption that the movement of the subject 100 or the object is smooth.

The description returns to FIG. 13.

After executing the definition processing in the time direction in step S106 or after determining that there is no high-fps image data in step S105, the CPU 41 executes the three-dimensionalization processing in step S107. The three-dimensionalization processing is processing of generating three-dimensional skeleton information (three-dimensional posture information) from a plurality of pieces of two-dimensional skeleton information which is two-dimensional data.

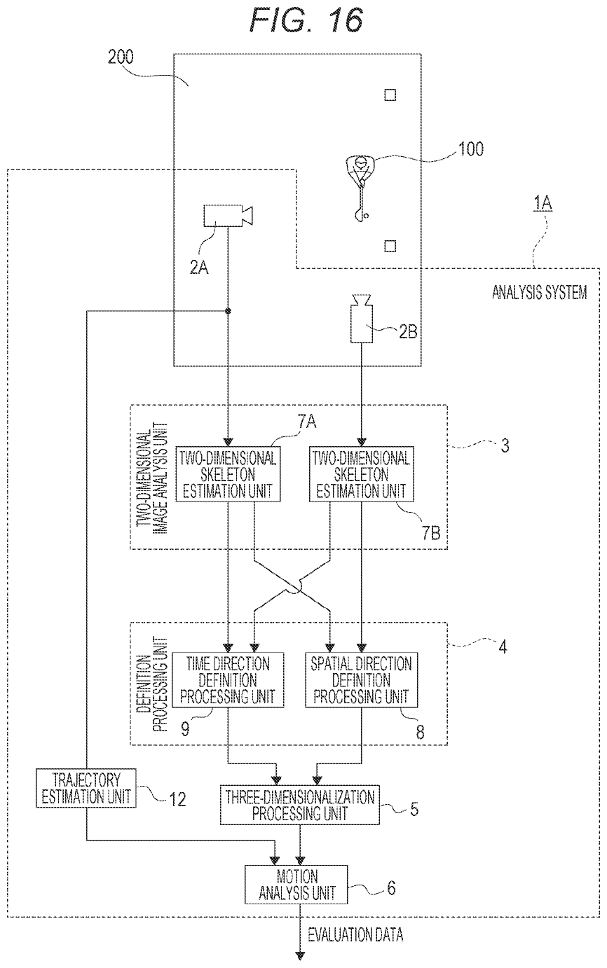

Next, in step S108, the CPU 41 performs motion analysis processing. In the motion analysis processing, the motion of the subject 100 and the motion of the object are analyzed. One example is illustrated in FIG. 15.

In the motion analysis process, the CPU 41 first executes swing analysis processing in step S301. This processing is processing of analyzing a position (e.g., it is a position of a joint and can also be said to be a posture), a moving direction, a moving speed, and the like of each unit such as the subject 100 and the object.

Next, in step S302, the CPU 41 executes swing evaluation processing. In the swing evaluation processing, the evaluation value of the swing is calculated on the basis of the position, the moving direction, the moving speed, and the like of each unit. The evaluation value may be a numerical value or information such as rank.

The description returns to FIG. 13 again.

After finishing the motion analysis processing in step S108, the CPU 41 finishes a series of processings shown in FIG. 13.

Note that, in the series of processings illustrated in FIG. 13, processing for outputting the evaluation value and the like to the user is omitted. The processing unit that performs these processings may be included in the analysis system 1 or may be included in an information processing apparatus outside the analysis system 1.

The series of processings illustrated in FIG. 13 may be executed for each imaging apparatus 2, for example. For example, every time the high-resolution image HRI output from the high-resolution camera 2A is input, the processings from step S101 to step S107 are performed. Furthermore, the processing in step S108 may be executed only once after all the high-resolution images HRI have been input. As a matter of course, each processing from step S101 to step S108 may be executed for one captured image.

### 2. Second Embodiment

<2-1. Configuration of Analysis System>

Similar to the analysis system 1A of the first embodiment, an analysis system 1A of the second embodiment includes a high-resolution camera 2A and a high-fps camera 2B, but the arrangement of the cameras is different.

Specifically, the high-resolution camera 2A is arranged on the right side of a subject 100, that is, behind the flying ball line so as to be able to image the trajectory of the golf ball for a long time.

Furthermore, the high-fps camera 2B is arranged in front of the subject 100.

This will be specifically described with reference to FIG. 16. Note that the same components as those illustrated in FIG. 1 are denoted by the same reference signs, and description thereof will be omitted as appropriate.

The captured image data output from the high-resolution camera 2A and the high-fps camera 2B is input into the two-dimensional image analysis unit 3, and thereby skeleton estimation processing is performed for each captured image data.

The output data from the two-dimensional image analysis unit 3 is input into a definition processing unit 4 to perform definition in the time direction and the spatial direction.

The three-dimensionalization processing unit 5 generates three-dimensional skeleton information (posture information) from the defined image data. The generated three-dimensional skeleton information is output to a motion analysis unit 6.

Information on the trajectory is also input into the motion analysis unit 6. Thus, an analysis system 1A includes a trajectory estimation unit 12.

The trajectory estimation unit 12 performs processing of estimating the trajectory of the golf ball after the subject 100 swings using the captured image data output from the high-resolution camera 2A. In the trajectory estimation processing, for example, a carry distance defined as a distance from the position of the golf ball before the swing to the striking point, a golf ball driving angle, a ball speed, a maximum arrival point, a golf driving direction, and the like are estimated. Furthermore, the distance of the run from the landing of the golf ball to the stop may be estimated, or the total flying distance of a carry distance and a run distance may be estimated.

Furthermore, the trajectory estimation unit 12 estimates how to bend the golf ball. For example, it is estimated whether a golf ball hit by the subject 100 is a draw ball that turns from right to left (a fade ball in the case of left-handed), a fade ball that turns from left to right (a draw ball in the case of left-handed), or a straight ball that does not turn left and right. In the processing of estimating the way of bending, the bending width of the ball may be further estimated.

The result data of the trajectory estimation processing is output to a motion analysis unit 6.

The motion analysis unit 6 analyzes the motion of the subject 100 on the basis of the three-dimensionalized skeleton information (posture information) and the trajectory estimation result. In this processing, as described in the first embodiment, the evaluation value of the swing is calculated from the movement of the joint or the like, but the evaluation value is calculated in consideration of the flying distance, the way ball bends and the like analyzed by the trajectory estimation unit 12 (alternatively, the evaluation value is corrected.).

<2-2. Processing Example>

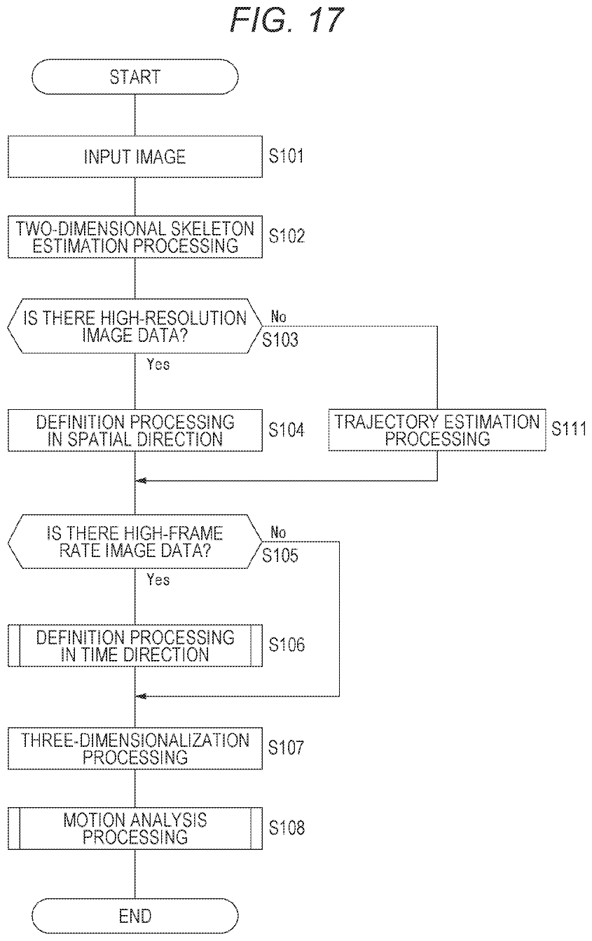

The trajectory estimation processing executed by the trajectory estimation unit 12 is only required to be executed, for example, anywhere in the series of processings illustrated in FIG. 13. One example is illustrated in FIG. 17. Note that processings similar to those in FIG. 13 are denoted by the same reference signs, and description thereof will be omitted as appropriate.

A CPU 41 receives an image input in step S101 and performs two-dimensional skeleton estimation processing in step S102.

In step S103, the CPU 41 determines whether or not there is image data having a resolution higher than the image data to be processed. In a case where there is high-resolution image data, the CPU 41 performs definition processing in the spatial direction in step S104.

On the other hand, in a case where there is no high-resolution image data, the image data to be processed is the data with the highest resolution. In this case, in step S111, the CPU 41 performs trajectory estimation processing using the image data to be processed.

The trajectory estimation result is used in the motion analysis processing in step S108.

Note that, in a case where there is a plurality of imaging apparatus capable of imaging having the same high resolution, the processing of step S111 may be executed by any of the imaging apparatuses. Moreover, there are cases of not able to estimate trajectory depending on an angle of view. In this case, the trajectory estimation processing in step S111 may be executed using the captured image data having the highest resolution among the imaging apparatuses most suitable for the trajectory analysis, that is, the imaging apparatuses capturing images from behind the flying ball line.

### 3. Third Embodiment

<3-1. Configuration of Analysis System>

An analysis system 1B of a third embodiment outputs not only the evaluation value as the analysis result of the swing but also the swing moving image. A user can grasp the evaluation of his/her swing while viewing the swing moving image.

Furthermore, the swing moving image is obtained by superimposing the skeleton information on the moving image data to be displayed.

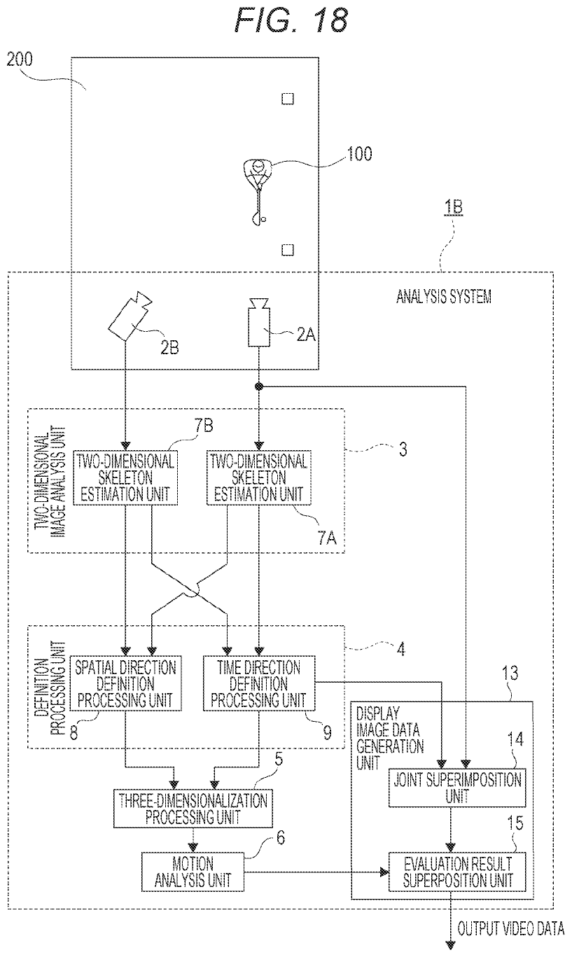

Specifically, first, the configuration of the analysis system 1B will be described with reference to FIG. 18.

Configurations of the high-resolution camera 2A, the high-fps camera 2B, the two-dimensional image analysis unit 3, the definition processing unit 4, the three-dimensionalization processing unit 5, and the motion analysis unit 6 are similar to those of the first embodiment, and thus, detailed description thereof will be omitted.

The analysis system 1B includes a display image data generation unit 13 that generates display image data to be presented to a user.

The display image data generation unit 13 includes a joint superimposition unit 14 and an evaluation result superimposition unit 15 that perform processing of superimposing various types of information.

The joint superimposition unit 14 acquires captured image data of the high-resolution camera 2A, acquires two-dimensional skeleton information defined in the time direction from the time direction definition processing unit 9, and superimposes the two-dimensional skeleton information on the image.

The captured image data on which the skeleton information is superimposed is output to an evaluation result superimposition unit 15.

The evaluation result superimposition unit 15 acquires an analysis result such as an evaluation value of the swing from the motion analysis unit 6, performs processing of superimposing and displaying the analysis result on the captured image data, and outputs the analysis result as output image data to the outside of the analysis system 1B.

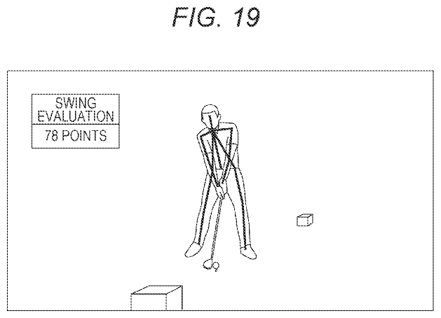

One example of the output video data is illustrated in FIG. 19.

As illustrated in the drawing, information on each joint of the subject 100 is displayed in a superimposed manner, and the evaluation value of the swing (78 points) is superimposed on the output video data.

By presenting such image data to the user, the user can efficiently confirm the state of her/his swing.

Note that the joint superimposition unit 14 may perform processing of superimposing the three-dimensional posture information acquired from the three-dimensionalization processing unit 5 on the captured image data of the high-resolution camera 2A.

<3-2. Processing Example>

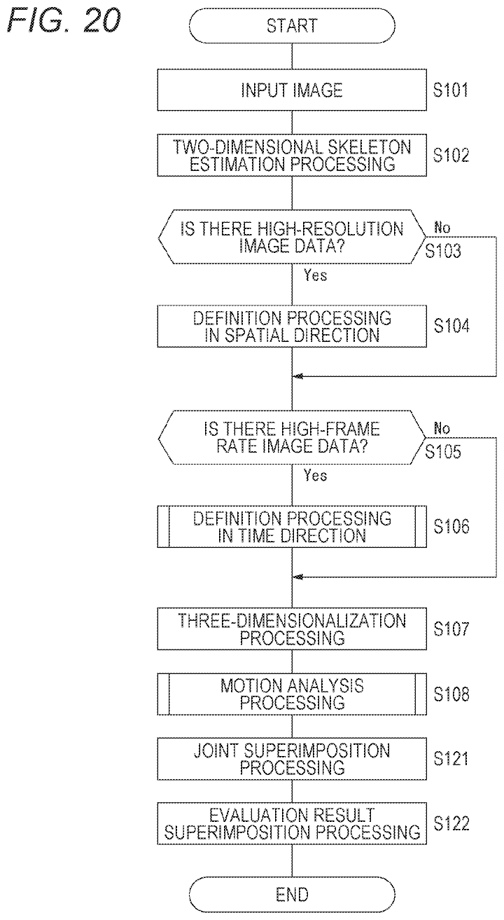

FIG. 20 illustrates an example of each processing executed by the CPU 41 in the third embodiment.

Note that processings similar to the processings described in the first embodiment are denoted by the same reference signs, and description thereof will be omitted as appropriate.

A CPU 41 executes each processing from step S101 to step S108 to perform two-dimensional skeleton estimation processing on the captured image data for each imaging apparatus 2, and further executes definition processing in the spatial direction and definition processing in the time direction as appropriate. Then, the CPU 41 calculates the evaluation value of the swing by three-dimensionalizing the skeleton information and performing motion analysis processing.

In step S121, the CPU 41 performs processing of superimposing skeleton information on the output video data to be presented to the user. As a result, the joint skeleton is superimposed on the display image.

Next, in step S121, the CPU 41 performs processing of superimposing the evaluation result. Thus, for example, a display image as illustrated in FIG. 19 is generated.

### 4. Fourth Embodiment

<4-1. Configuration of Analysis System>

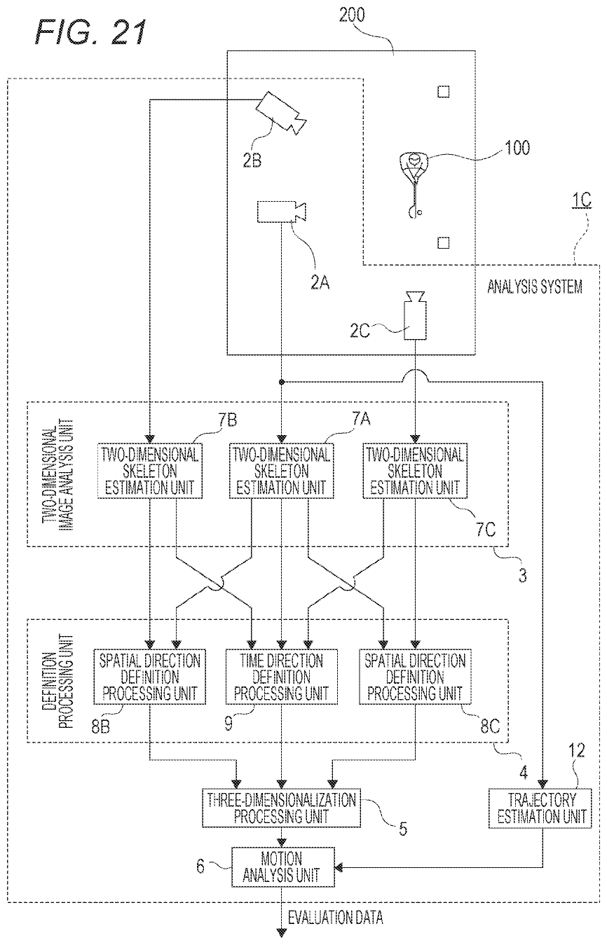

An analysis system may include three or more imaging apparatuses 2. Specifically, an analysis system 1C in a fourth embodiment includes three imaging apparatuses 2. A specific configuration will be described with reference to FIG. 21.

The analysis system 1C further includes another high-fps camera 2C in addition to a high-resolution camera 2A and a high-fps camera 2B.

The high-resolution camera 2A is disposed behind the fly ball line, and is capable of capturing the swing of the subject 100 and the trajectory of the golf ball.

The captured image data acquired from the high-resolution camera 2A is output to a two-dimensional skeleton estimation unit 7A of a two-dimensional image analysis unit 3.

The two-dimensional skeleton estimation unit 7A estimates the skeleton of the subject 100 for each captured image data.

Similarly, the two-dimensional skeleton estimation units 7B and 7C estimate the skeleton of the subject 100 on the basis of the captured image data output from the high-fps cameras 2B and 2C.

The high-resolution image data and the skeleton information output from the two-dimensional skeleton estimation unit 7A are output to a time direction definition processing unit 9 of a definition processing unit 4.

The time direction definition processing unit 9 performs time direction interpolation processing on the high-resolution image. Herein, the image data used for the interpolation processing in the time direction is captured image data captured by the imaging apparatus 2 capable of high-fps imaging. In the present example, two high-fps cameras 2B and 2C are provided as the imaging apparatuses 2 capable of high-fps imaging, but any captured image may be used.

For example, which one of the high-fps cameras 2B and 2C is used to perform interpolation may be determined for each joint. That is, there may be a joint interpolated by the high-fps camera 2B and a joint interpolated by the high-fps camera 2C.

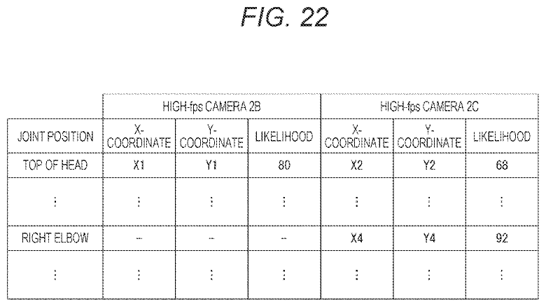

For which captured image of the high-fps cameras 2B and 2C is used, for example, it is conceivable to use likelihood information on joint positions estimated for each joint. This will be specifically described with reference to FIG. 22.

FIG. 22 is a table illustrating estimation results of the two-dimensional skeleton estimation units 7B and 7C that perform skeleton estimation processing on the basis of the low-resolution image LRI among the three two-dimensional skeleton estimation units 7A, 7B, and 7C included in the two-dimensional image analysis unit 3.

The position (X coordinate, Y coordinate) on the image and the likelihood are associated with each joint of the subject 100. The likelihood is, for example, a numerical value of 0 to 100, and the higher the numerical value, the higher the accuracy of the estimation result.

The likelihood information is information output together with information on each joint position estimated as a processing result of image recognition processing in a case where the image recognition processing using CNN or the like is applied to the captured image data.

As a result of applying the image recognition processing to the captured image data obtained from the high-fps camera 2B, the position of the top of the head of the subject 100 is estimated to be the position specified by the X coordinate “X1” and the Y coordinate “Y1” on the image. Furthermore, the likelihood of the estimation result is “80”.

Meanwhile, as a result of applying the image recognition processing to the captured image data obtained from the high-fps camera 2C, the position of the top of the head of the subject 100 is estimated to be the position specified by the X coordinate “X2” and the Y coordinate “Y2” on the image. Furthermore, the likelihood of the estimation result is “68”.

From these results, it can be seen that the captured image data obtained from the high-fps camera 2B has higher accuracy in the estimation result of the position of the top of the head of the subject 100.

Therefore, it is preferable to use the captured image data obtained from the high-fps camera 2B as the image to be used when the definition processing in the time direction is performed on the position of the top of the head in the high-resolution image HRI captured by the high-resolution camera 2A.

Furthermore, the estimated position of the right elbow of the subject 100 obtained as a result of applying the image recognition processing to the captured image data obtained from the high-fps camera 2B is the X coordinate “−” and the Y coordinate “−”, and the likelihood thereof is “−”. This indicates that the likelihood cannot be measured, indicating that the position of the right elbow cannot be estimated. For example, a case where occlusion occurs, such as a case where the right elbow is hidden by the body of the subject 100, is assumed. Alternatively, in a case where the image is out of focus, the likelihood may be low, and in a case where the focus is significantly deviated, the likelihood may be unmeasurable.

Meanwhile, the estimated position of the right elbow of the subject 100 obtained as a result of applying the image recognition processing to the captured image data obtained from the high-fps camera 2C is the X coordinate “X4” and the Y coordinate “Y4”, and the likelihood thereof is “92”.

Therefore, the right elbow of the subject 100 can be estimated with higher accuracy by using the captured image data obtained from the high-fps camera 2C.

That is, it is preferable to use the captured image data obtained from the high-fps camera 2C as the image to be used when the definition processing in the time direction is performed on the position of the right elbow of the subject 100 in the high-resolution image HRI captured by the high-resolution camera 2A.

As described above, in the definition processing in the time direction, it is desirable to select the image to be used for each joint of the subject 100 as appropriate. Furthermore, the selection is desirably performed on the basis of likelihood information, for example.

Note that this example is an example of the definition processing in the time direction, but the same applies to the definition processing in the spatial direction. For example, in a case where there is a plurality of imaging apparatuses 2 capable of high-resolution imaging, in a case where the captured image with low resolution is defined in the spatial direction, it is desirable to decide which high-resolution image HRI to use among the high-resolution images HRI obtained from the plurality of imaging apparatuses 2 capable of high-resolution imaging on the basis of the likelihood information for each joint.

Note that it may be decided which captured image of the high-fps cameras 2B and 2C is used without using the likelihood information. For example, in a case where the images captured by the high-fps cameras 2B and 2C are images with different resolutions, high-resolution images may be used. Furthermore, in that case, for the joint for which the joint position cannot be estimated, the highest resolution image among the images for which the joint position can be estimated may be used.

Similar to the analysis system 1A according to the second embodiment, an analysis system 1C according to the present embodiment includes a trajectory estimation unit 12.

The processing executed by the trajectory estimation unit 12 is similar to that of the trajectory estimation unit 12 in the second embodiment, and the description thereof will be omitted.

<4-2. Processing Example>

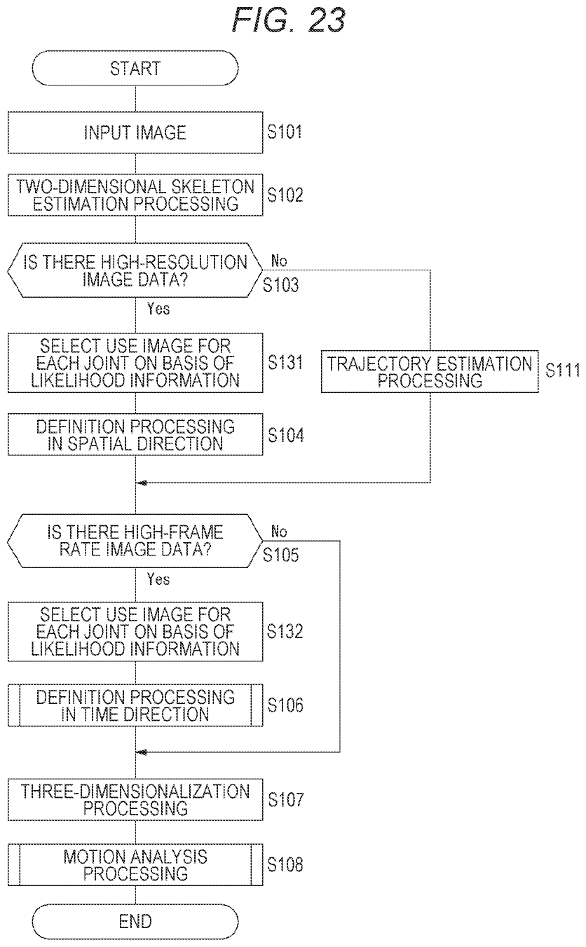

One example of each processing executed by the CPU 41 in this example is illustrated in FIG. 23.

Note that processings similar to the processings described in the first embodiment and second embodiment are denoted by the same reference signs, and description thereof will be omitted as appropriate.

The CPU 41 performs two-dimensional skeleton estimation processing on the captured image data of each imaging apparatus 2 by executing each processing of steps S101 and S102.

Next, in step S103, the CPU 41 determines whether or not there is image data having a resolution higher than that of the image data to be processed.

In a case where there is no high-resolution image data, since the image data to be processed is the image data having the highest resolution, the trajectory estimation processing using the image data to be processed is performed.

On the other hand, in a case where there is image data having a higher resolution than the image data to be processed, the CPU 41 selects the image data to be used for the definition processing in the spatial direction for each joint on the basis of the likelihood information for each joint in step S131. However, in a case where there is only one piece of image data having a higher resolution than the image data to be processed, the selection processing using the likelihood information (i.e., the processing of step S131) may be not executed.

After the use image is selected on the basis of the likelihood information, the CPU 41 executes the definition processing in the spatial direction in step S104.

After the processing of step S104 is executed or after the processing of step S111, the CPU 41 determines whether or not there is image data having a higher fps than the image data to be processed in step S105.

In a case where there is the image data of high fps, the CPU 41 selects the image data to be used for the definition processing in the time direction for each joint on the basis of the likelihood information for each joint in step S132. However, in a case where there is only one piece of image data having a higher fps than the image data to be processed, the selection processing using the likelihood information (i.e., the processing of step S132) may be not executed.

After the use image is selected for each joint, the CPU 41 executes the definition processing in the time direction in step S106, acquires the three-dimensionalized skeleton information (i.e., the three-dimensional posture information) obtained by performing three-dimensional processing step S107, and executes the motion analysis processing in step S108. In the motion analysis processing, swing analysis of the subject 100 is performed on the basis of the trajectory information on the golf ball estimated in step S111.

By executing such processing, the motion of the subject can be analyzed on the basis of the skeleton information estimated with higher accuracy, and a more accurate evaluation value can be calculated.

### 5. Modification Examples

In the above-described definition processing in the time direction, the example of using the low-resolution image LRI obtained from the imaging apparatus 2 or the like capable of imaging at high-fps has been described. In that case, it is conceivable to use the likelihood information even in a case where there is only one high-fps camera 2B as the imaging apparatus 2 capable of imaging at high-fps.

For example, for a joint whose likelihood is a predetermined value (e.g., 50) or more, definition processing in the time direction is performed on the basis of joint position information estimated from the low-resolution image LRI captured by the high-fps camera 2B.

On the other hand, for the joint having the likelihood less than the predetermined value, the possibility that the motion of the subject 100 can be accurately analyzed decreases even if the definition in the time direction is performed on the basis of the joint position information estimated by the low-resolution image LRI. In this case, the high definition of the joint position may be performed by performing linear interpolation, interpolation using a quadratic approximate curve, or the like using high-resolution images HRI captured at preceding and subsequent timings among the high-resolution images HRI obtained from the high-resolution camera 2A.

For example, referring to FIG. 3, each joint position at the time point t2 may be estimated using a plurality of high-resolution images HRI1, HR2, HR3 and the like.

Therefore, even in a case where the low-resolution image LRI is not suitable for joint position estimation, the definition processing in the time direction of the joint position can be appropriately executed, and the motion analysis of the subject 100 can be suitably performed.

Furthermore, in a case where the high-fps camera 2B can perform imaging with a resolution of 480 p and the high-fps camera 2C can perform imaging with a resolution of 240 p, it is preferable to use the captured image of the high-fps camera 2B in a case where the definition processing in the time direction is executed. However, for a joint having low likelihood information, a captured image of the high-fps camera 2C may be used.

The output video data output from an evaluation result superimposition unit 15 in the third embodiment is basically obtained by superimposing each piece of information on the captured image of the high-resolution camera 2A. However, for a frame for which skeleton estimation has failed, each piece of information may be superimposed on an image captured by another imaging apparatus 2.

Furthermore, the output video data can be selected by a user. For example, output video data in which various types of information are superimposed on the captured image of the high-resolution camera 2A may be presented to the user who has checked the angle of view from the front. Moreover, output video data in which various types of information are superimposed on the captured image of the high-fps camera 2B may be presented to the user who wants to check the angle of view from an oblique direction.

Therefore, appropriate output video data can be provided on the basis of the angle that the user wants to check.

Note that, in each of the examples described above, the example has been described in which the plurality of imaging apparatuses 2 has different imaging performance, but the imaging apparatuses 2 may have the same imaging performance. Even in the same imaging apparatuses 2, accuracy of joint information estimated varies depending on the angle of view. Therefore, the joint information with low accuracy can be corrected, interpolated, or modified to the information with high accuracy, and the accuracy of the posture information estimated for the subject 100 can be improved.

### 6. Summary

As described in each example above, the information processing apparatus (the analysis system 1) that analyzes the feature amount information on the subject 100 includes the definition processing unit 4 that performs definition processing on the feature amount information (posture information) on the subject 100 specified from the image.

The feature amount information is, for example, posture information, or the like. Furthermore, as the definition processing, definition processing in a time direction, definition processing in a spatial direction, or the like can be considered.

By performing the definition processing on the feature amount information, the feature amount can be more accurately grasped.

As illustrated in FIG. 2, the analysis system 1 may include a smoothing processing unit 11 that performs smoothing processing on the feature amount information after the definition processing.

Therefore, the feature amount information is corrected to be more accurate.

Therefore, various types of processing based on the feature amount information can be appropriately performed.

As described in each embodiment, the feature amount information may be posture information on the subject 100.

As a result, the posture information on the subject 100 is defined in the time direction and is defined in the spatial direction.

Therefore, the posture of the subject 100 can be more accurately specified.

As described in each embodiment, the image in which the feature amount information is specified may include the first captured image (high-resolution image HRI) captured by the first imaging apparatus (high-resolution camera 2A) and the second captured image (low-resolution image LRI) captured by the second imaging apparatus (high-fps camera 2B) different from the first imaging apparatus.

By defining the feature amount information about the subject 100 such as the posture information using the captured images captured by the plurality of imaging apparatuses, the feature amount information can be grasped more accurately.

Thus, image processing based on accurate feature amount information can be performed at a subsequent stage.

As described in each embodiment, the first captured image (high-resolution image HRI) may be an image having a higher resolution than the second captured image (low-resolution image LRI).

Thus, as for the second imaging apparatus (the high-fps camera 2B) that captures the second captured image, the imaging apparatus 2 that can capture only a captured image with a lower resolution than the first imaging apparatus (the high-resolution camera 2A) that captures the first captured image can be adopted.

Therefore, as the first imaging apparatus and the second apparatus, it is possible to use the inexpensive imaging apparatus 2 and reduce the cost as compared with a case where an imaging apparatus capable of high-resolution imaging is adopted.

As described in each embodiment, the second captured image (low-resolution image LRI) may be an image captured at a higher frame rate than the first captured image (high-resolution image HRI).

As a result, as the first imaging apparatus (high-resolution camera 2A) that captures the first captured image (high-resolution image HRI), the imaging apparatus 2 that can capture only a captured image at a lower frame rate than the second imaging apparatus (high-fps camera 2B) that captures the second captured image (low-resolution image LRI) can be adopted.

Therefore, as the first imaging apparatus and the second imaging apparatus, it is possible to use the inexpensive imaging apparatus 2 and reduce the cost as compared with a case where imaging apparatuses capable of imaging at a high frame rate are adopted.

As described in each embodiment, the definition processing unit 4 may perform definition in the spatial direction using the first captured image (high-resolution image HRI) with respect to the feature amount information (posture information) specified from the second captured image (low-resolution image LRI) as the definition processing.

Therefore, it is possible to correct the spatial direction of the feature amount information specified from the captured image having a relatively low resolution.

Therefore, the feature amount information such as posture information with high accuracy can be obtained in the spatial direction.

As described in each embodiment, the definition processing unit 4 may perform definition in the time direction using the second captured image (low-resolution image LRI) with respect to the feature amount information (posture information) specified from the first captured image (high-resolution image HRI) as the definition processing.

Therefore, missing information in the time direction can be compensated for the feature amount information specified from the captured image having a relatively low frame rate.

Therefore, it is possible to more accurately grasp the time change of the feature amount information such as the posture information on the subject 100.

As described in each embodiment, the analysis system 1 (1A, 1B, 1C) may include the feature amount specifying unit (two-dimensional skeleton estimation unit 7, 7A, 7B, 7C) that specifies the feature amount information (posture information) from the image.

Since both the feature amount specifying unit and the definition processing unit 4 are provided in the analysis system 1, each processing can be smoothly performed.

Therefore, efficient processing can be achieved.

As described in each embodiment, the feature amount specifying unit (two-dimensional skeleton estimation unit 7, 7A, 7B, 7C) may specify the posture information on the subject 100 as the feature amount information by performing skeleton estimation processing of estimating the skeleton of the subject 100.

Therefore, the posture information based on the skeleton information estimated for the subject 100 is obtained, and the definition processing for the skeleton information is performed.

Therefore, highly accurate posture information on the subject 100 can be obtained.

As described in each embodiment, the analysis system 1 (1A, 1B, 1C) may include the three-dimensionalization processing unit 5 that generates three-dimensional posture information using the feature amount information (posture information) after the definition processing is applied.

Therefore, feature amount information such as skeleton information obtained from the two-dimensional image is three-dimensionalized.

Therefore, the posture of the subject 100 can be more accurately specified.

As described in each embodiment, the analysis system 1 (1A, 1B, 1C) may include the motion analysis unit 6 that analyzes the motion of the subject 100 using the three-dimensional posture information.

Thus, the motion of the subject 100 can be analyzed with high accuracy on the basis of the three-dimensionalized posture information.

Therefore, in a case where various types of processing are performed on the basis of the specified motion of the subject 100, appropriate processing can be performed.

As described in the fourth embodiment, in a case where there is a plurality of high-resolution imaging apparatuses (high-resolution cameras) that have captured an image with higher resolution than the second captured image (low-resolution image LRI), the definition processing unit 4 may select the first captured image (high-resolution image HRI) used for definition in the spatial direction from among the high-resolution images on the basis of the likelihood information in the high-resolution image for each high-resolution imaging apparatus.

Therefore, an appropriate first captured image is selected in the definition processing.

Therefore, the feature amount information can be appropriately defined, and the processing in the subsequent stage can be highly accurate.

As described in the fourth embodiment, in a case where there is a plurality of high-frame rate imaging apparatuses (high-fps cameras) that have captured images with a higher frame rate than the first captured images (high-resolution images HRI), the definition processing unit 4 may select the second captured image (low-resolution images LRI) to be used for definition in the time direction from among the high-frame rate images on the basis of the likelihood information in the high-frame rate images for each high-frame rate imaging apparatuses.

Therefore, an appropriate second captured image is selected in the definition processing.

Thus, the feature amount can be appropriately defined, and the processing in the subsequent stage can be highly accurate.

As described in the fourth embodiment, the likelihood information may be calculated for the joint of the subject 100.

Thus, an appropriate captured image is selected for each joint of the subject 100.

Therefore, appropriate definition processing of the feature amount is performed for each joint, and the processing in the subsequent stage can be made highly accurate.

As described in the third embodiment, the analysis system 1 (1A, 1B, 1C) may include the display image data generation unit 13 that generates display image data in which posture information is superimposed on an image.

As a result, a display image useful for analyzing the posture information on the subject 100 is generated.

Therefore, it is possible to appropriately analyze the posture information on the subject 100.

An information processing method executed by the analysis system 1 (1A, 1B, 1C) is to perform definition processing on feature amount information (posture information) about the subject 100 specified from an image.

An analysis system 1 (1A, 1B, 1C) as an imaging system includes a first imaging apparatus (e.g., a high-resolution camera 2A) that captures a first captured image (e.g., a high-resolution image HRI), a second imaging apparatus (e.g., a high-fps camera 2B) that captures a second captured image (e.g., a low-resolution image LRI) having at least one of a resolution or a frame rate different from that of the first captured image, and a definition processing unit 4 that performs definition processing on the first captured image using the second captured image.

Note that the effects described in the specification are merely examples and are not limited, and other effects may be exerted.

In addition, the above-described examples can be combined in any manner as long as the combination is not impossible.

### 7. Present Technology

The present technology can also adopt the following configurations.

(1)

An information processing apparatus, including

a definition processing unit that performs definition processing on feature amount information regarding a subject specified from an image.

(2)

The information processing apparatus according to (1), further including

a smoothing processing unit that performs smoothing processing on the feature amount information after the definition processing.

(3)

The information processing apparatus according to any one of (1) or (2), in which

the feature amount information is posture information on the subject.

(4)

The information processing apparatus according to any one of (1) to (3), in which

the image includes a first captured image captured by a first imaging apparatus and a second captured image captured by a second imaging apparatus different from the first imaging apparatus.

(5)

The information processing apparatus according to (4), in which

the first captured image is an image having a higher resolution than the second captured image.

(6)

The information processing apparatus according to any one of (4) or (5), in which

the second captured image is an image captured at a higher frame rate than the first captured image.

(7)

The information processing apparatus according to (5), in which

the definition processing unit performs, as the definition processing, definition in a spatial direction using the first captured image for the feature amount information specified from the second captured image.

(8)

The information processing apparatus according to (6), in which

the definition processing unit performs, as the definition processing, definition in a time direction using the second captured image for the feature amount information specified from the first captured image.

(9)

The information processing apparatus according to any one of (1) to (8), further including

a feature amount specifying unit that specifies the feature amount information from the image.

(10)

The information processing apparatus according to (9), in which

the feature amount specifying unit specifies posture information on the subject as the feature amount information by performing skeleton estimation processing of estimating a skeleton of the subject.

(11)

The information processing apparatus according to any one of (1) to (10), further including

a three-dimensionalization processing unit that generates three-dimensional posture information using the feature amount information to which the definition processing has been applied.

(12)

The information processing apparatus according to (11), further including

a motion analysis unit that performs motion analysis of the subject using the three-dimensional posture information.

(13)

The information processing apparatus according to (7) in which,

in a case where there is a plurality of high-resolution imaging apparatuses that has captured an image with a higher resolution than the second captured image,

the definition processing unit selects the first captured image to be used for definition in the spatial direction from among the high-resolution images on the basis of likelihood information in the high-resolution image for each of the high-resolution imaging apparatuses.

(14)

The information processing apparatus according to (8), in which,

in a case where there is a plurality of high-frame rate imaging apparatuses that has captured an image with a higher frame rate than the first captured image,

the definition processing unit selects the second captured image to be used for definition in the time direction from among the high-frame rate images on the basis of likelihood information in the high-frame rate image for each of the high-frame rate imaging apparatuses.

(15)

The information processing apparatus according to any one of (13) or (14), in which

the likelihood information is calculated for a joint of the subject.

(16)

The information processing apparatus according to (3), further including

a display image data generation unit that generates display image data in which the posture information is superimposed on the image.

(17)

An information processing method, in which

an information processing apparatus executes definition processing with respect to feature amount information regarding a subject specified from an image.

(18)

An imaging system including:

a first imaging apparatus that captures a first captured image;

a second imaging apparatus that captures a second captured image with at least one of a resolution or a frame rate different from that of the first captured image; and

a definition processing unit that performs definition processing on the first captured image using the second captured image.

### REFERENCE SIGNS LIST

1, 1A, 1B, 1C Analysis system (information processing apparatus)

2A High-resolution camera (first imaging apparatus)

2B, 2C High-fps camera (second imaging apparatus)

5 Three-dimensionalization processing unit

6 Motion analysis unit

7, 7A, 7B, 7C Two-dimensional skeleton estimation unit (feature amount specifying unit)

8, 8A, 8B Spatial direction definition processing unit (definition processing unit)

9 Time direction definition processing unit (definition processing unit)

11 Smoothing processing unit

1. An information processing apparatus, comprising
a definition processing unit that performs definition processing on feature amount information regarding a subject specified from an image.

2. The information processing apparatus according to claim 1, further comprising
a smoothing processing unit that performs smoothing processing on the feature amount information after the definition processing.

3. The information processing apparatus according to claim 1, wherein
the feature amount information is posture information on the subject.

4. The information processing apparatus according to claim 1, wherein
the image includes a first captured image captured by a first imaging apparatus and a second captured image captured by a second imaging apparatus different from the first imaging apparatus.

5. The information processing apparatus according to claim 4, wherein
the first captured image is an image having a higher resolution than the second captured image.

6. The information processing apparatus according to claim 4, wherein
the second captured image is an image captured at a higher frame rate than the first captured image.

7. The information processing apparatus according to claim 5, wherein
the definition processing unit performs, as the definition processing, definition in a spatial direction using the first captured image for the feature amount information specified from the second captured image.

8. The information processing apparatus according to claim 6, wherein
the definition processing unit performs, as the definition processing, definition in a time direction using the second captured image for the feature amount information specified from the first captured image.

9. The information processing apparatus according to claim 1, further comprising
a feature amount specifying unit that specifies the feature amount information from the image.

10. The information processing apparatus according to claim 9, wherein
the feature amount specifying unit specifies posture information on the subject as the feature amount information by performing skeleton estimation processing of estimating a skeleton of the subject.

11. The information processing apparatus according to claim 1, further comprising
a three-dimensionalization processing unit that generates three-dimensional posture information using the feature amount information to which the definition processing has been applied.

12. The information processing apparatus according to claim 11, further comprising
a motion analysis unit that performs motion analysis of the subject using the three-dimensional posture information.

13. The information processing apparatus according to claim 7, wherein,
in a case where there is a plurality of high-resolution imaging apparatuses that has captured an image with a higher resolution than the second captured image,
the definition processing unit selects the first captured image to be used for definition in the spatial direction from among the high-resolution images on a basis of likelihood information in the high-resolution image for each of the high-resolution imaging apparatuses.

14. The information processing apparatus according to claim 8, wherein,
in a case where there is a plurality of high-frame rate imaging apparatuses that has captured an image with a higher frame rate than the first captured image,
the definition processing unit selects the second captured image to be used for definition in the time direction from among the high-frame rate images on a basis of likelihood information in the high-frame rate image for each of the high-frame rate imaging apparatuses.

15. The information processing apparatus according to claim 13, wherein
the likelihood information is calculated for a joint of the subject.

16. The information processing apparatus according to claim 3, further comprising
a display image data generation unit that generates display image data in which the posture information is superimposed on the image.

17. An information processing method, wherein
an information processing apparatus executes definition processing with respect to feature amount information regarding a subject specified from an image.

18. An imaging system comprising:
a first imaging apparatus that captures a first captured image;
a second imaging apparatus that captures a second captured image with at least one of a resolution or a frame rate different from that of the first captured image; and
a definition processing unit that performs definition processing on the first captured image using the second captured image.
